(19) United States
(12) Patent Application Publication
(10) Pub. No.: US 2007/0072715 A1
(43) Pub. Date: Mar. 29, 2007

(54) Chain drive

(75) Inventors: Alios Hinterstocker, Sauerlach (DE); Martin Bodensteiner, Erding (DE); Sandra Ketterl, Moosinning (DE); Petra Doll, Endlhausen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JOH. WINKLHOFER & SOHNE GMBH UND CO. KG, Munchen (DE)

(21) Appl. No.: 11/525,391

(22) Filed: Sep. 22, 2006

(30) Foreign Application Priority Data
Sep. 27, 2005 (DE) 10 2005 046 183.2

(51) Int. Cl. F16H 55/30; F16H 55/06

(52) U.S. Cl. 474/152; 474/161; 474/164

(57) ABSTRACT

A chain drive in an internal combustion engine, with at least two shafts having at least one chain wheel each, wherein at least one chain wheel is formed of a toothed ring and a hub element, which are connected to one another through detachable attachment elements, and the hub element is connected to a shaft by a central attachment system. The abutment surface of the hub with the shaft and the attachment surface between the toothed ring and the hub element are arranged in a manner offset with respect to one another.

### CROSS-REFERENCE TO RELATED APPLICATION

The present application claims the benefit of priority of German Patent Application No. 10 2005 046 183.2 filed on Sep. 27, 2005. The entire text of the priority application is incorporated herein by reference in its entirety.

### FIELD OF THE DISCLOSURE

The disclosure refers to a chain drive in an internal combustion engine, comprising at least two shafts and at least one chain wheel, wherein at least one chain wheel is formed of several parts of a toothed ring and a hub element, which are connected to one another via detachable attachment elements, and wherein the hub element is connected to the shaft through a central attachment system.

### BACKGROUND OF THE DISCLOSURE

The valve control of an internal combustion engine usually comprises a chain drive with an endless chain extending between a driving chain wheel on the crankshaft and a driven chain wheel on an associated camshaft. Chain wheels for this use exist in various designs. They are for instance formed integral and disk-shaped starting out from the toothed ring extending to the shaft seat, or they are composed of several parts, e.g. of a toothed ring and a wall connecting a hub with the toothed ring. Most recently, the development of the chain wheels was particularly concerned with the damping of vibrations and noise that might be produced by the contact of the chain of the control drive with the chain wheel.

In this context, DE 103 16 608 describes the structure of a chain wheel for a chain drive, which is composed of several parts of a toothed ring and a carrier sheet connected therewith, wherein the carrier sheet is a spring steel sheet member. The carrier sheet is formed in parallel to the toothed ring and is connected via spring tension sleeves with the toothed ring. Furthermore, a hub member accommodating the shaft and connected to the sheet member may be arranged in the center of the spring steel sheet member. The carrier sheet of spring steel will be used for damping chain incitements due to its elastic material properties.

Another problem, which frequently occurs in connection with a control chain drive, depends on the construction of the engines, and particularly the installation spaces that are increasingly becoming smaller. In the case of some engine applications, the central screw coupling of the shaft-hub connection of a chain wheel cannot be released for service work due to installation space reasons. These problems particularly occur in the case in which the engine block is directly connected to the chain shaft and the cylinder block. Repairs thus require complex reconstruction work connected with increased costs and long maintenance times.

### SUMMARY OF THE DISCLOSURE

It is the object of the present disclosure to provide a chain drive, in which a simple exchange or disassembly of the chain wheel is also possible in small installation spaces.

This object is solved by a chain drive in an internal combustion engine comprising at least two shafts and at least one chain wheel, wherein at least one chain wheel is formed of several parts of a toothed ring and a hub element, which are connected to one another through detachable attachment elements, and wherein the hub element is connected to the shaft through a centrally arranged attachment means, in that the abutment surface of the hub element with the shaft and the attachment surface between the toothed ring and the hub element are arranged in a manner axially offset with respect to each other.

The present disclosure enables an exchange of the chain wheel without a complete disassembly of the engine becoming necessary. This is enabled by two attachments that are arranged separately from one another, which on the one side serve for attaching the toothed ring on the hub element and, on the other hand, for attaching the hub element on the shaft shoulder. Since the toothed ring is not centrally connected to the shaft, and since the abutment surface and the attachment surface are arranged in a mariner axially offset with respect to one another, the attachment elements may simply be released between the toothed ring and the hub element, even if the hub element cannot be released from the shaft shoulder. Depending on the design of the toothed ring, i.e. particularly depending on the size of the inner aperture, the toothed ring may be shifted relative to the shaft to exchange the chain in a simple manner, or the toothed ring may be threaded over the hub element if the toothed ring has to be replaced. During operation, a respective multi-piece chain wheel is supplied as ready assembled component, and it may be attached on the shaft as a conventional chain wheel so that additional installation steps are not required.

Advantageously, the end face of the shaft may be spaced apart from the attachment surface between the toothed ring and the hub element to a greater extent than from the abutment surface between the hub element and the shaft. Caused by this embodiment, the position of the abutment surface and the attachment surface is precisely defined. Since the abutment surface between the hub element and the shaft is arranged further away from the toothed ring than the attachment surface between the toothed ring and the hub element, sufficient space is provided to release the attachment elements between the toothed ring and the hub element from one another also in installed condition.

According to a further preferred embodiment, the hub element may be formed with a central portion and at least two spoke elements, which extend outwardly from opposing sections of the central portion. The design of the hub element with two spoke elements is responsible for a safe support of the hub element on the toothed ring, since the hub element is attached via the spoke elements on two opposing points on the toothed ring.

The spoke elements may preferably on their outer ends be provided with through openings. In assembled condition, the ends provided with the through openings rest on the toothed ring and may thereby, e.g. by means of screws or other suitable connection means, be fasted on one another.

Advantageously, the surface of the central portion facing away from the toothed ring and the surface of the toothed ring facing the hub element may be arranged in a manner axially offset with respect to one another. This ensures that the central portion of the hub element does not directly rest on the toothed ring but that a certain distance is provided between both elements, which forms the space required for disassembly of the toothed ring.

According to a further preferred embodiment, the outer circumference of the central portion of the hub element may be smaller than the inner diameter of the toothed ring. This ensures that the toothed ring can be guided over the hub element by shifting and tilting.

According to another preferred embodiment, the central portion of the hub element may have a positive fitting hub connection for accommodating a shaft shoulder, e.g. a key surface. By providing a positive hub connection, it is possible when mounting the chain wheel to precisely position same on the shaft shoulder, since the hub element may be displaced in the area of the positively fitting hub connection.

Advantageously, the spoke elements may be angled from the central portion in such a way that the surfaces of the central portion of the hub element facing away from the toothed ring and the outer ends of the spoke elements are formed in parallel to one another. This embodiments provides an especially simple way of achieving a distance between the central portion of the hub element and the toothed ring, that means that by a simple double angling of the spokes. By choosing the length of the spokes appropriately, it is possible to provide hub elements with a different distance from the toothed ring in a simple manner.

According to a further preferred embodiment, the central portion of the hub element may be formed circularly, wherein the central portion projects axially over the spoke elements at the side facing away from the toothed ring during operation. This embodiment also serves for the positioning of the central portion of the hub element and particularly of the surface of the central portion facing away from the toothed ring, relative to the toothed ring.

Advantageously, the outer diameter of the central portion may be smaller than the inner diameter of the toothed ring.

According to a further preferred embodiment, the hub element and the toothed ring may be provided with positioning means in the area of the mutual rest surfaces. Advantageously, the positioning means may be formed as pins and recesses. This embodiment ensures that the hub element can also correctly be mounted on the toothed ring even after a disassembly, that means also if the installation conditions do not allow a view or only a restricted view. Pins and recesses are an especially simple type of positioning means, of course all other known positioning means can also be used.

According to a further preferred embodiment, a through opening in the toothed ring may be associated to each through opening of a hub element. In this manner, a simple attachment of the hub elements on the toothed ring through attachment means inserted into the through openings is possible.

Advantageously, an internal thread may be formed in each through opening of the toothed ring. Furthermore, the attachment means may comprise screws. Since the openings of the toothed ring comprise internal threads, it is possible to use screws which do not project over the toothed ring on the surface of the toothed ring opposing the hub element, and the space required is additionally reduced. Furthermore, screws are attachment means which can easily be opened and used again if the space conditions are small.

According to a further preferred embodiment it may be provided that the toothed ring in the area of each through opening is formed with a projection projecting over the inner diameter. Thus, it is possible to form the through openings at least partially in the area of the projections, this embodiment is particularly advantageous in the case of very small toothed rings, since larger screws can also be used and a better seat can thereby be obtained.

According to another preferred embodiment, the screws may be screwed through the through openings of the hub element into the through openings of the toothed ring provided with an internal thread, wherein the distance between the end surface of the screw facing away from the toothed ring and the toothed ring at most corresponds to the distance between the surface of the central portion of the hub element facing away from the toothed ring and the toothed ring. Since the attachment elements between the toothed ring and the hub element do not project over the hub element, they can also be released in the case of very small installation conditions.

Advantageously, the distance between the end surface of the screw facing away from the toothed ring and the surface of the central portion of the hub element facing away from the toothed ring may correspond at least to the thickness of the toothed ring. If a respective distance is kept, it is possible to fully screw the screw out of the toothed ring and to displace the toothed ring relative with respect to the hub element, even if the hub element itself is not directly accessible.

The disclosure further refers to a multi-piece chain wheel for a generic control drive, comprising a toothed ring and a hub element which are connected to one another through detachable attachment elements, and wherein the hub element is connected to a shaft through a central attachment system, wherein the abutment surface of the hub element with the shaft and the attachment surface between the toothed ring and the hub element are arranged in a manner axially displaced with respect to each other.

The present disclosure further provides a method of disassembling a multi-piece chain wheel, comprising the release of the attachment elements between the hub element and the toothed ring and displacing the toothed ring relatively, particularly axially, with respect to the hub element.

According to a preferred embodiment, the toothed ring may be threaded out across the hub element.

As already described, the hub element after releasing the attachment element remains on the shaft between the hub element and the toothed ring, and the toothed ring can easily be displaced, wherein this toothed ring may still remain on the shaft. By skillful displacement it is, however, also possible to displace the toothed ring in such a manner that it may be guided over the hub element.

### BRIEF DESCRIPTION OF THE DRAWINGS

A preferred embodiment of the present disclosure is described closer by means of a drawing.

FIG. 1 shows a multi-piece chain wheel of a control drive according to the disclosure according to a first embodiment, and

FIG. 2 shows a multi-piece chain wheel of the control drive according to the disclosure according to a further embodiment.

### DETAILED DESCRIPTION OF THE DISCLOSURE

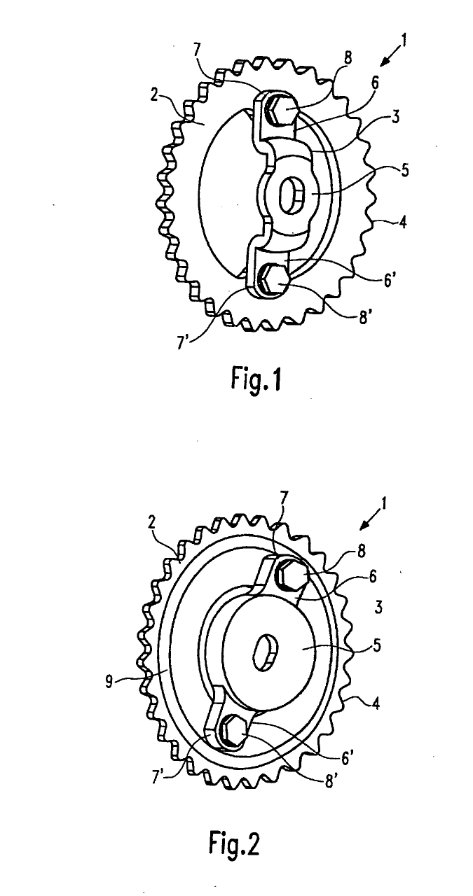

The chain wheel 1 shown in FIG. 1 has a multi-piece structure composed of a toothed ring 2 and a hub element 3, which are connected to one another. The toothed ring 2 is formed as a flat ring with an outer toothing 4.

The hub element 3 is formed as an oblong element, comprising a central portion 5 as well as two spoke elements 6, 6′, which extend in a manner opposing each other from the central element 5. The spoke elements rest on the toothed ring 2 with their ends 7, 7′ opposing the central portion 5, and are each provided with a through opening into which screws 8 are inserted to connect the hub element 3 with the toothed ring 2.

The central portion 5 of the hub element is formed in a longitudinally extended manner, however, it is smaller than the inner opening of the toothed ring. The hub element 3 also has a through opening in the central portion 5, with a key surface for receiving a shaft shoulder, wherein the hub element may be positioned as desired through the key surface on the shaft shoulder.

The distance between the surface of the toothed ring 2 facing the hub element 3 and the surface of the screw head, i.e. the common thickness of the ends of the spoke elements 7, 7′ resting on the toothed ring and the cross sectional thickness of the screw head 9, is smaller than the distance between the surface of the central portion 5 facing away from the toothed ring 2 with respect to the surface of the toothed ring 2 facing the hub element. In order to provide a respective distance, the spoke elements 6, 6′ are angled from the central portion 5 and extend first of all towards the toothed ring 2, to then extend after another angling in parallel to the surface of the central portion 5 and in parallel to the surface of the toothed ring 2. The distance of the central portion from the toothed ring is defined by the length of the spoke elements.

Another embodiment of a multi-piece chain wheel is shown in FIG. 2. Identical components are characterized in connection with FIG. 2 with the same reference numerals as in FIG. 1.

Contrary to the toothed ring 2 shown in FIG. 1, the toothed ring according to FIG. 3 is formed with a smaller through opening, i.e. with a smaller inner diameter. Furthermore, the toothed ring 2 does not have the same cross-section across the entire ring portion, but the toothed ring 2 is farmed in the area of the outer toothing 4 with a reducing cross section, i.e. a circular step 9 is formed on the toothed ring 2, from which the cross section reduces constantly across the outer toothing.

Furthermore, the hub element 3 is not provided with angled spoke elements, rather, the spoke elements 6, 6′ extend in parallel to the surface of the toothed ring 2. Since the toothed ring 2 has a smaller diameter, a larger section of the spoke elements 6, 6′ rests on the toothed ring. The attachment is also implemented by means of screws, which extend through the hub elements up to the toothed ring.

The central portion of the hub element 3 is, contrary to FIG. 1, not formed oblong but circular, wherein in the center the through opening with the key surface is arranged. The outer diameter of the central portion that is formed circularly is smaller than the inner diameter of the toothed ring 2. Furthermore, the thickness of the hub element in the area of the central portion is larger than in the area of the spoke elements. In this embodiment, the surface of the central portion 5 facing away from the toothed ring 2 is further spaced apart from the toothed ring than the surface of the screw head facing away from the toothed ring 2.

We claim:

1. A chain drive in an internal combustion engine, comprising at least two shafts having at least one chain wheel each, wherein at least one chain wheel (1) is formed of a toothed ring (2) and a hub element (3), the toothed ring (2) and hub element (3) being connected together through detachable attachment elements, the hub element (3) being connected to a one of the shafts by a central attachment system, wherein an abutment surface of the hub element (3) connected to said one of the shafts and an attachment surface between the toothed ring (2) and the hub element (3) being arranged in a manner axially offset with respect to each other.

2. A chain drive as claimed in claim 1, and wherein an end face of the shaft to which the hub element is connected is spaced apart from the attachment surface between the toothed ring (2) and the hub element (3) to a greater extent than the abutment surface between the hub element (3) and the shaft to which the hub element is connected.

3. A chain drive as claimed in claim 1, wherein the hub element (3) is formed with a central portion (5) and at least two spoke elements (6, 6′), which extend towards the outside from opposing sections of the central portion (5).

4. A chain drive as claimed in claim 3, wherein the spoke elements (6, 6′) are provided with through openings on the outer ends (7, 7′).

5. A chain drive as claimed in claim 3, wherein a surface of the central portion (5) facing away from the toothed ring (2) and a surface of the toothed ring (2) facing the hub element (3) are arranged in a manner axially offset with respect to one another.

6. A chain drive as claimed in claim 3, wherein the outer circumference of the central portion (5) of the hub element (3) is smaller than the inner diameter of the toothed ring (2).

7. A chain drive as claimed in claim 3, wherein the central portion (5) of the hub element (3) has a positive hub connection to receive a shaft shoulder.

8. A chain drive as claimed in claim 3, wherein the spoke elements (6, 6′) are angled from the central portion (5) to such an extent that a surface of the central portion (5) of the hub element (3) angled from the toothed ring (2) and the outer ends (7, 7′) of the spoke elements (6, 6′) are arranged in parallel with one another.

9. A chain drive as claimed in claim 3, wherein the central portion (5) of the hub element (3) is formed circularly, wherein the central portion (5) axially projects over the spoke elements on a side facing away from the toothed ring (2) during operation.

10. A chain drive as claimed in claim 9, wherein the external diameter of the central portion (5) is smaller than the internal diameter of the toothed ring (2).

11. A chain drive as claimed in claim 1, wherein the hub element (3) and the toothed ring (2) are provided with positioning means in an area of mutual rest surfaces.

12. A chain drive as claimed in claim 1, wherein the positioning means are formed as pins and recesses.

13. A chain drive as claimed in claim 1, wherein a through opening in the toothed ring (2) is associated with each through opening of the spoke element (6, 6′)

14. A chain drive as claimed in claim 13, wherein an internal thread is formed in each through opening of the toothed ring (2).

15. A chain drive as claimed in claim 13, wherein the toothed ring (2) is provided with a projection projecting over the internal diameter in the area of each through opening.

16. A chain drive as claimed in claim 1, wherein the attachment elements comprise screws (8, 8′).

17. A chain drive as claimed in claim 4, wherein the attachment elements comprise screws (8, 8′), and the screws (8, 8) are screwed through the through openings of the spoke elements (6, 6′) into the through openings of the toothed ring (2) provided with an internal thread, wherein the distance between the end surface of the screw (8, 8′) facing away from the toothed ring (2) and the toothed ring (2) corresponds at most to the distance between the surface of the central portion of the hub element (3) facing away from the toothed ring (2) and the toothed ring (2).

18. A chain drive as claimed in claim 17, wherein the distance between the end surface of the screw (8, 8′) facing away from the toothed ring (2) and the surface of the central portion (5) of the hub element (3) facing away from the toothed ring (2) corresponds at least to the thickness of the toothed ring (2).

19. A multipart chain wheel for a chain drive comprising a toothed ring (2) and a hub element (3), which are connected together through detachable attachment elements, and wherein the hub element (3) is connected to a shaft by a central attachment system, and wherein an abutment surface of the hub element connected to the shaft and the attachment surface between the toothed ring (2) and the hub element (3) are arranged in a manner axially offset with respect to one another.

20. A method for disassembling a multipart chain wheel, comprising:
releasing attachment elements between a hub element (3) and a toothed ring (2), and
displacing the toothed ring (2) with respect to the hub element (3).

21. A method for disassembling a multipart chain wheel as claimed in claim 20, and threading out the toothed ring (2) across the hub element (3).

22. A chain drive as claimed in claim 7, wherein the shaft shoulder is a key surface.

23. The method of claim 20, and displacing the toothed ring (2) radially with respect to the hub element (3).
